(19) United States
(12) Patent Application Publication
(10) Pub. No.: US 2023/0404114 A1
(43) Pub. Date: Dec. 21, 2023

(54) Immersion Defrost Basket Systems & Methods

(71) Applicant: Immersion Systems, Inc., Topeka, KS (US)

(72) Inventors: John CANTRELL, Prairie Village, KS (US); Richard POWERS, Overland Park, KS (US); Roger SHEALY, Fayetteville, GA (US); Mark CHURCHILL, Grain Valley, MO (US)

(21) Appl. No.: 18/198,690

(22) Filed: May 17, 2023

Related U.S. Application Data
(60) Provisional application No. 63/342,695, filed on May 17, 2022.

(51) Int. Cl. A23L 3/365; A23L 3/00; A23L 3/36

(52) U.S. Cl. CPC A23L 3/365; A23L 3/001; A23L 3/364

(57) ABSTRACT

A basket system for improving the process of defrosting frozen objects, such as food product packages, where multiple objects are positioned in a permeable walled immersion basket to be lowered into, moved within, and removed from, a defrosting liquid. The system includes flow channel defining spacer plates made of thermally conductive material structured to be positioned within the immersion basket in layers between the multiple objects to be defrosted. Defrosting liquid, such as in a temperature-controlled water bath, may flow freely through the permeable walls of the immersion basket, through the channels created by the spacer plates, and into contact with the plates and the multiple objects being defrosted. The system helps prevent the multiple frozen objects from forming a solid block that would inhibit the defrosting process.

### CROSS REFERENCES TO RELATED APPLICATIONS

This application claims the benefit under Title 35 United States Code § 119(e) of U.S. Provisional Patent Application Ser. No. 63/342,695; Filed: May 17, 2022; the full disclosure of which is incorporated herein by reference.

### BACKGROUND OF THE INVENTION

### 1. Field of the Invention

The present invention relates generally to systems and methods for defrosting and/or deicing objects. The present invention relates more specifically to a basket system and method for improved defrosting of multiple objects within a permeable container during the process of immersing the container with objects into, out from, and within, a body of defrosting fluid.

### 2. Description of the Related Art

Current systems and methods for defrosting frozen objects, such as packaged food products, suffer from a tendency for multiple frozen objects to freeze together into a solid block when first immersed into a defrosting liquid. Thin layers of water, or of the defrosting fluid, on the surfaces of the objects can quickly freeze and bind the multiple packages or objects together in a manner that prevents the free flow of the defrosting fluid in and around the objects. This can cause very uneven defrosting and greatly lengthen the time it takes to defrost multiple objects. The problem, therefore, is how to keep multiple objects separated to prevent them from being frozen together and also separated enough to permit an effective flow of defrosting liquid between them to improve the defrost process (duration and evenness). Importantly, such separation methods must take up the least amount of space possible or the volume of food that can be thawed or deiced will be reduced. In addition, this separation and fluid flow must be maintained while the entire mass of objects is being contained within a confined space and repeatedly subjected to immersion and removal from the defrosting fluid. In addition to fluid flow, the ability to structurally conduct heat from the surrounding fluid to the center of the product is very desirable and is facilitated by the dividers.

### SUMMARY OF THE INVENTION

The basket assembly of the present invention is designed to be used in conjunction with systems of the type shown and described in U.S. Patent Application Publication No.: US2020/0284515 A1; Publication Date: Sep. 10, 2020; Title: Immersion Systems & Methods for Washing & Performing Other Tasks; the full disclosure of which is incorporated herein by reference.

In the present invention, one or more aluminum (or other thermally conductive material) plates get placed into a permeable container or basket, then packets of frozen food are added, and then additional plates etc., until the permeable basket is full. A lid for the permeable container can optionally be used. These plates rapidly transfer heat into the frozen food packets. As the frozen food is immersed into temperature-controlled fluid or water, and then in and out of, and optionally raised and lowered within, the temperature-controlled fluid or water, the thermal plates, which act as heat sinks, rapidly transfer the heat energy from the water into the frozen food items. In addition, the open flow structure of the plates allows fluid or water to more evenly flow through and/or across the plates for continuous energy transfer. Such an open flow structure can allow flow to occur in either direction and be a very effective means of heat transfer. The structure of the edge of the thermal plate can also assist in the transfer of heat to the center of the product. In general, the repetitive vertical movement of the system up and down within a bath of fluid or water causes a flow of some force into and through the layered plates and objects, which pushes and moves the elements of the assembly in a kind of stirring motion that greatly facilitates a rapid but controlled thermal transfer.

### BRIEF DESCRIPTION OF THE DRAWINGS

FIG. 1 is an exploded assembly perspective view of the basket system of a first representative embodiment of the present invention shown as it would be used with multiple frozen items.

FIGS. 2A & 2B are a top plan view and a side end profile view of the immersion basket of the first representative embodiment of the system of the present invention shown with the permeable cover plate in place.

FIG. 3 is a cross-sectional view taken along Section Line A-A′ in FIG. 2A, showing a fully assembled and loaded basket of a first representative embodiment of the system of the present invention.

FIG. 4 is a top perspective view of a spacer plate of a first representative embodiment of the basket system of the present invention.

FIG. 5 is an exploded assembly perspective view of an alternate representative embodiment of the basket system of the present invention shown as it would be used with multiple frozen food packets.

FIG. 6 is a top perspective view of the immersion basket of the alternate representative embodiment of the system of the present invention shown emptied of the layered plates and food packages.

FIG. 7 is a top perspective view of a spacer plate of the alternate representative embodiment of the basket system of the present invention.

FIG. 8 is a cutaway perspective view of the alternate representative embodiment of the basket system of the present invention shown loaded with multiple objects spaced apart with spacer plates.

### DETAILED DESCRIPTION OF THE EXEMPLARY EMBODIMENTS

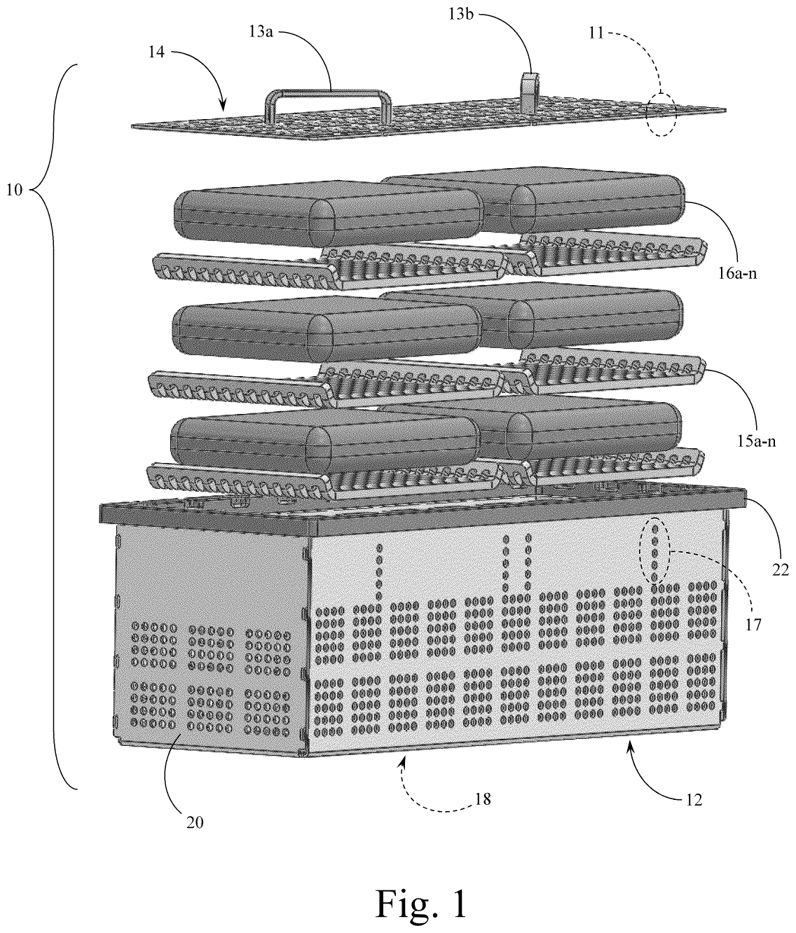

Reference is made first to FIG. 1 which is an exploded assembly perspective view of the basket system of a first representative embodiment of the present invention shown as it would be used with multiple frozen food packets. Basket assembly 10 is made up of basket container 12, multiple open flow spacer plates 15a-n, and a permeable cover plate 14. Basket container 12 is constructed with perforated or permeable walls and base that permit the flow of liquid therethrough. Basket container 12 may preferably have a structured perimeter top edge 22 that acts as a frame and optionally facilitates engaging the basket with basket holders used in the overall immersion defrost system. In the embodiment shown, basket container 12 is a rectangular box with an open top, perforated or permeable side walls 20, and a perforated or permeable floor 18. Perimeter edge 22 may be structured around the open top of the rectangular box shape to optionally facilitate hanging or holding the basket 12 within the immersion defrost system that is being used.

Additional open flow spacer plates 15a-n may be used to cover the top layer of food product packages 16a-n although it is preferable to use permeable cover plate 14 as shown in FIG. 1. Permeable cover plate 14 is preferably a semi-rigid plate with an array of apertures similar to those structured into each of the permeable side walls 20. Handles 13a & 13b are positioned on the plate to allow for ease of insertion or removal from basket 12. Tabs 11 may be positioned on the perimeter edge of permeable cover plate 14 to engage with apertures 17 at various levels on the side walls 20 of basket 12, to facilitate the retention of the stack of spacer plates 15a-n and food product packages 16a-n in basket 12 during the process of raising and lowering the assembly into, within, or from the immersion fluid. Tabs 11 allow for permeable cover plate 14 to be located at varying heights within basket assembly 10. Accordingly, a range of apertures 17 are provided to allow for adjustment of the positioning of cover plate 14 to best secure the layered arrangement of food product packages 16a-n and spacer plates 15a-n within basket 12 while the immersion process is repeatedly carried out.

In FIG. 1, six open flow spacer plates 15a-n are used in pairs (three layers) to separate six food product packages 16a-n also arranged in pairs. More or fewer of such layers may be established and more or fewer of such spacer plates 15a-n of varying sizes may be used per layer. To an extent, the arrangement will be determined by the size of the individual food product packages 16a-n being handled. Although FIG. 1 shows food product packages 16a-n of a consistent size and shape, use of the system of the present invention does not require that this be the case. Food products and food product packages of regular or irregular sizes and shapes may be accommodated. The use of multiple spacer plates per layer accommodates this versatility and there can be a variety of spacer plate sizes.

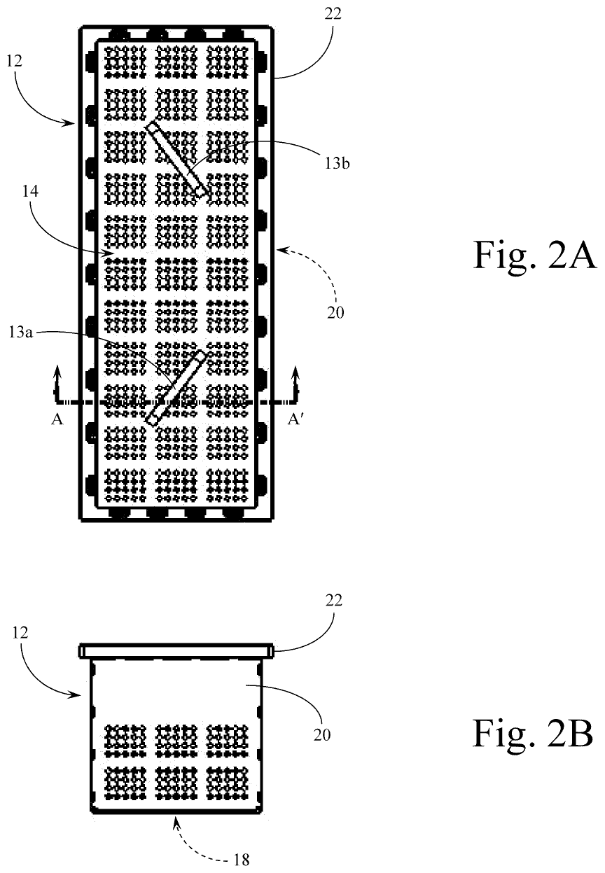

Reference is next made to FIGS. 2A & 2B which are a top plan view and a side end profile view of the immersion basket of the first representative embodiment of the system of the present invention shown with the permeable cover plate in place. In general, the structure of basket container 12 may vary according to the structure and geometry of the system within which it is intended to be used. The basket container 12 shown in FIGS. 2A & 2B is sized and structured to be used with a system that receives two side by side containers that are slid into a support frame that then lowers and raises the assembly into and from a temperature-controlled bath of water (or other fluid mixtures). Such a system may also accommodate four basket containers receiving two smaller containers side by side followed by two more smaller containers side by side. Of course, the depth of each container may be varied as well, generally without concern for the structure of the system into which the containers are inserted, as long as the required lateral geometry and spacing are maintained. Other systems may utilize only a single basket container or three or four basket containers. In each case, the size of the individual container may vary according to the food products being handled.

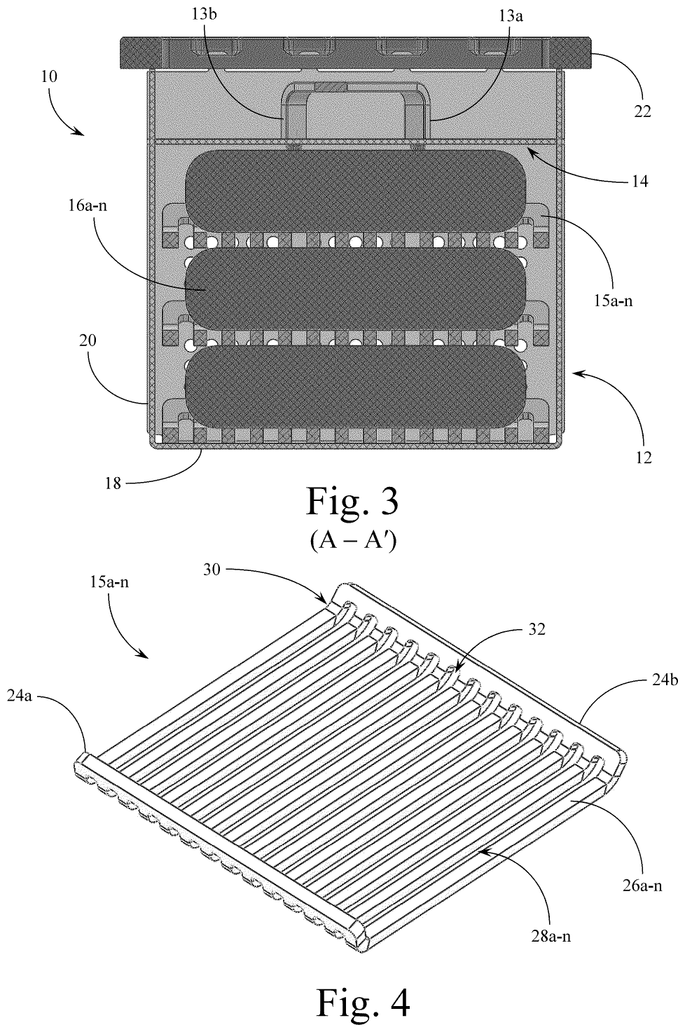

In FIG. 2A, basket container 12, as viewed from above, is generally covered with permeable cover plate 14. The permeable side walls and base are not visible in this view but permit the flow of liquid through all sides and the top and bottom. While the side walls are preferably permeable, they do not need to be for the system to function according to its intended purpose. Basket container 12 may preferably have a structured perimeter top edge 22 that acts as a frame and facilitates engaging the basket with basket holders used in the overall immersion defrost system. In the embodiment shown, basket container 12 is a rectangular box with an open top, perforated or permeable side walls 20, and a perforated or permeable floor 18. Perimeter edge 22 may be structured around the open top of the rectangular box shape to optionally facilitate hanging or holding the basket 12 within the immersion defrost system that is being used as described above. Permeable cover plate 14 is preferably a semi-rigid plate with an array of apertures and is sized to fit within the dimensions of the container side walls and the perimeter edge. Handles 13a & 13b are shown again secured to the cover plate to allow for ease of use in the manner described. Section Line A-A′ in FIG. 2A provides the angle of cross-section shown in detail in FIG. 3. FIG. 2B is a side end profile view of basket container 12, as viewed from the end typically introduced first into the immersion system. The permeable cover plate is not visible in this view, being fit fully into the open top of the container. Basket container 12 is again shown to have structured perimeter top edge 22 that has an overhang that optionally facilitates engaging the basket with basket holders used in the overall immersion defrost system. Once again, in the embodiment shown, basket container 12 is a rectangular box with an open top, perforated or permeable side walls 20, and a perforated or permeable floor 18. While elongated rectangular baskets may be preferable, the baskets could also be square, and the system would function accordingly.

Reference is next made to FIG. 3 which is a cross-sectional view taken along Section Line A-A′ in FIG. 2A, showing a fully assembled and loaded basket of the first representative embodiment of the system of the present invention. In this view, basket system 10 of the present invention is shown loaded with multiple open flow spacer plates 15a-n separating multiple food product packages 16a-n. In this view, taken across the width of the rectangular box shaped basket 12, the open flow channels that are established by the layering of the plates 15a-n and food product packages 16a-n, can be seen. These open flow channels, combined with the optional perforations in side walls 20, perforations in the optional cover plate 14, and optional perforations in floor 18, allow for the flow of defrosting fluid into and through the basket container 12 and the layers of food product packages 16 being defrosted. This flow is further facilitated by the repeated movement of the basket system into, out of, and within the bath of defrosting fluid, as the fluid flows into the channels on immersion into the bath and back out of the channels on removal from the bath.

Described above as an objective of the present invention, these layered structures allow fluid to flow into the assembly from the bottom, as when the assembly is being lowered (with some force) into the defrost liquid bath, and into the assembly from the top, as when the assembly is being drawn up out from the defrost liquid bath. In either direction, fluid flows around the food product packages 16a-n, through the channels in the open flow spacer plates and around the edge profiles conducting heat into the thermal plates 15a-n, and though the permeable side walls 20. This flow process creates the greatest thermal energy exchange between the food products, the plates, and the fluid bath while still providing sufficient physical support and containment to the products as they are moved forcefully through the immersion system.

Reference is next made to FIG. 4 which is a perspective view from above of one of the open flow spacer plates 15a-n of the basket system of the present invention. Spacer plate 15 (one of multiple such plates used with the present system) is preferably an array of spaced parallel bars 26a-n that define multiple parallel open flow channels 28a-n. The parallel bars 26a-n are fixed in their spaced arrangement by cross-members 24a & 24b positioned at the ends of the bars 26a-n. Significantly, cross-members 24a & 24b are offset from the plane in which spaced parallel bars 26a-n are positioned in such a manner to transfer the maximum amount of thermal energy. This offset, achieved in this embodiment by angled bend 30 seen in FIG. 4, ensures that the ends 32 of flow channels 28a-n are not obstructed by cross-members 24a & 24b and facilitate the draining of fluid from the plate during use. In this manner, fluid flow may occur to and from the ends of spacer plate 15 even when the objects being defrosted are stacked above and below in contact with plate 15. Spacer plates 15a-n in the preferred embodiment are made of a material such as aluminum with good thermal conductivity but may be constructed of any rigid or flexible material with or without good thermal conductivity. Spaced parallel bars 26a-n in the embodiment shown preferably each have a square cross-section to increase the contact surface area with the objects being defrosted and with the flowing fluid, although bars with other cross-sectional geometries may provide similar results. The thermal transfer achieved is a result of the combination of the heat transferred through the material of the plate with the heat transferred by way of the flowing defrost fluid.

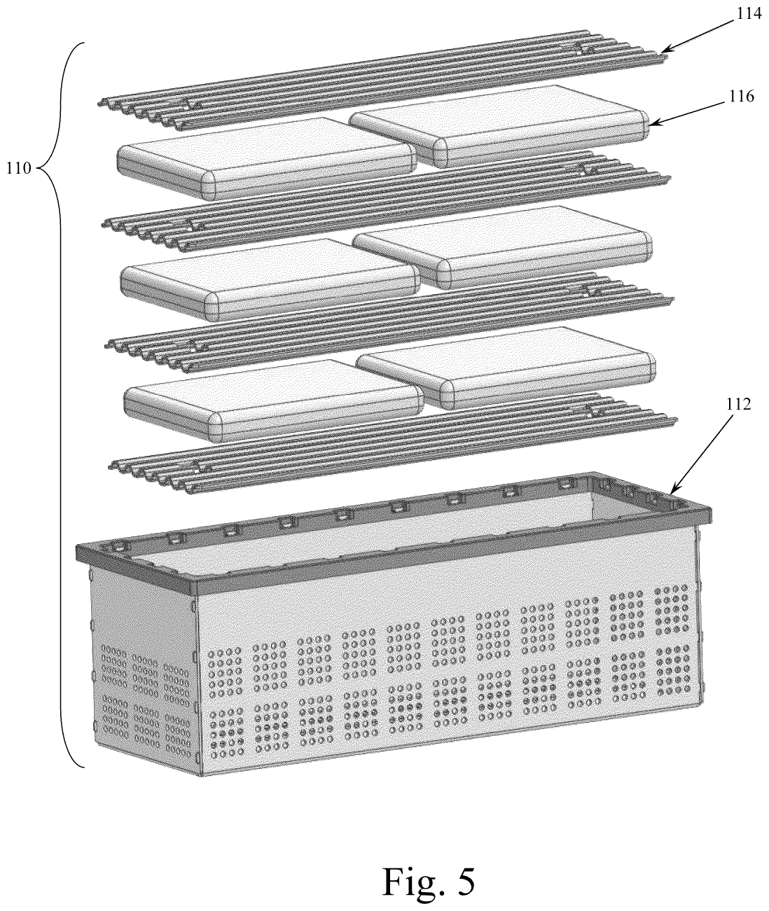

Reference is made next to FIG. 5 which is an exploded assembly perspective view of an alternate exemplary embodiment of the basket system of the present invention shown as it would be used with multiple frozen food packets. This alternate basket assembly 110 is made up of basket container 112 and multiple corrugated spacer plates 114. Basket container 112 is constructed with perforated or permeable walls and base that together permit the flow of liquid therethrough. Basket container 112 may preferably have a structured perimeter top edge that acts as a frame and optionally facilitates engaging the basket with basket holders used in the overall immersion system. In FIG. 5, four corrugated spacer plates 114 are shown positioned between three layers of food product packages 116. More or fewer such layers may be established.

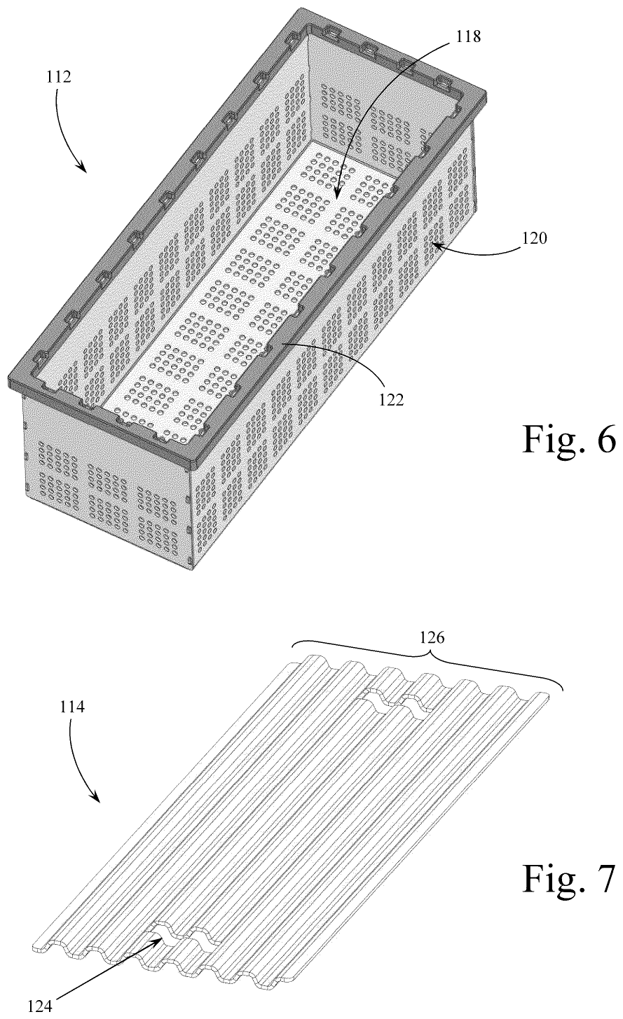

Reference is next made to FIG. 6 which is a top perspective view of the immersion basket 112 of the alternate exemplary embodiment of the system of the present invention shown emptied of the layered plates and food packages. The structure of basket container 112 may vary according to the structure and geometry of the system within which it is intended to be used. In the embodiment shown, basket container 112 is a rectangular box with an open top, perforated or permeable side walls 120, and a perforated or permeable floor 118. Perimeter edge 122 may be structured around the open top of the rectangular box shape to optionally facilitate hanging or holding the basket 112 within the immersion system that is being used.

Reference is next made to FIG. 7 which is a perspective view from above of a corrugated spacer plate 114 of the alternate exemplary embodiment of the basket system of the present invention. Plate 114 (one of multiple such plates used with the present system) is preferably a rigid rectangular aluminum plate, formed (pressed) into a corrugated structure as shown, and sized to be positioned in layers within the basket container described above. Handle apertures 124 may be positioned on each end of the corrugated plate to facilitate handling of the plate and its insertion and removal from the basket assembly. Corrugations 126 in plate 114 are spaced and sized to permit the free flow of liquid through the channels created by corrugations 126. The peak edges (upper and lower) of the corrugations are positioned to contact the surfaces of the food packets and to thereby serve as heat transfer interfaces for defrosting the objects. These same surface profiles reduce the surface contact area but increase the contact pressure per square inch. This increased force or pressure will impinge into the high spots of uneven produce being thawed, quickly resulting not only in more contact surface area, the impingement of the plate into the product results in the thermal energy being applied to the still more frozen areas reducing the natural thermal resistance of the product being thawed. As the system moves in a fluid such as water, the specific gravity of the product is reduced greatly. Coupled with rapid movement of the system, the product moves and/or is repositioned within resulting in a translocation or mixing of the thawed product that occurs at greater and greater levels, further increasing the thermal transfer rate to the core of the product. The combination of keeping the plate on frozen product versus thawed product and the thermal circulation of the product within the bag or package rotates large amounts of heat to the core that is not possible without a carefully designed thermal plate. Corrugations 126 may preferably be sinusoidal (as shown in FIG. 7) to present a larger surface area in contact with food product packages 116. Other corrugation forms (such as saw tooth) may be used, albeit with a reduction in direct thermal contact between the aluminum plate and the food product packages. The plates 114 in the preferred embodiment are made of a material such as aluminum with good thermal conductivity but may be constructed of any rigid or semi-rigid material with or without good thermal conductivity.

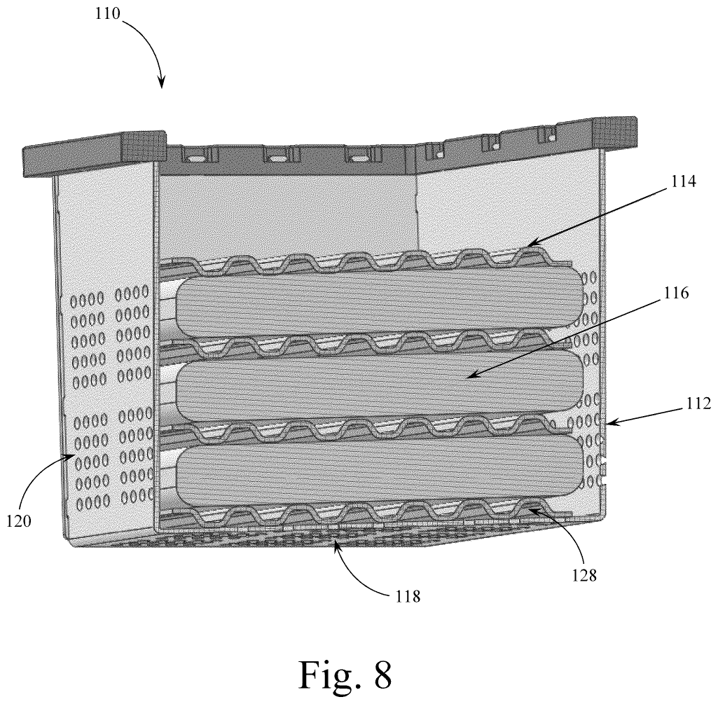

Reference is finally made to FIG. 8, which is a cutaway perspective view of the basket system 110 of the alternate exemplary embodiment of the present invention shown loaded with multiple objects 116 spaced apart with spacer plates 114. In this cutaway view, taken across the width of the rectangular box shaped basket 112, channels 128 established by the layering of the plates 114 and food product packages 116, can be seen. These channels 128, combined with the optional perforations in side walls 120 and in floor 118, allow for the flow of defrosting fluid into and through the basket container 112 and the layers of food product packages 116 being defrosted. This flow is further facilitated by the repeated movement of the basket system into, out of, and within the bath of defrosting fluid, as the fluid flows into the channels on immersion into the bath and back out of the channels on removal from the bath.

Although the present invention has been described in conjunction with a number of exemplary embodiments, those skilled in the art will recognize modifications to these embodiments that still fall within the spirit and scope of the invention. Because the basic goals of the system of the present invention include keeping objects being defrosted separated and establishing open fluid flow paths between the objects, various structures and geometries may be anticipated that achieve these goals in the same or a similar manner as the exemplary embodiments described. Other types of substantially parallel structural members that define channels through which defrosting fluid may flow may be implemented. These may include, without limitation, parallel spaced hollow tubes (circular or square cross-section) with or without transverse (through the tube wall) apertures, parallel bars with U-channel cross-sections, parallel bars with I-beam cross-sections, parallel bars adhered to or sandwiched between one or more solid plates, a solid plate with an array of parallel grooves cut into the plate, as well as other arrangements, all of which are anticipated.

The spacer plates of the present invention may be implemented with concurrently produced permeable containers sized and structured to accommodate the dimensions of one or more of the proprietary immersion systems described. The invention has been described with a variety of features that facilitate the handling of the spacer plates although additional handling features may be incorporated that do not significantly detract from the functionality of the system. Further add-on functionalities will be anticipated by those skilled in the art that do not depart from the spirit and scope of the invention as set forth in the appended claims. Although the present invention has been described for use with frozen food products that are packaged while being defrosted, such packaging is not required for the system to operate properly. Some food products may be sized and shaped as to not require packaging when frozen.

Finally, although the present invention has been described, and finds its best use, with an immersion system that repeatedly moves a quantity of objects in and out of a defrost fluid to create circulation, it is also appropriate for use with a system that does or does not circulate defrost fluid around and through a static permeable container stacked with the spacer plates described herein. As an example, use of the present invention with a static sink filled with water would still offer great benefit versus placing all of the items to be thawed within that same sink one on top of the other, as is currently common. The present invention may also find use, albeit less efficient, as a static system within air or with defrost systems that circulate dry or humidified air with the defrosting of food products.

We claim:

1. A basket system for facilitating the defrosting of multiple frozen objects being immersed into, moved within, and removed from a volume of defrosting fluid, the basket system comprising;
a basket container having an open top and a permeable floor; and
a plurality of thermally conductive plates sized and shaped to be positioned in layers within the basket container, each of the thermally conductive plates comprising an array of substantially parallel structural members that define channels through which defrosting fluid may flow;
wherein multiple frozen objects to be defrosted are layered between the plurality of thermally conductive plates, which together are layered within the basket container, thereby providing channels that permit the free flow of defrosting fluid between the layered plates and objects to be defrosted.

2. The basket system of claim 1 wherein the array of parallel structural members comprises a plurality of spaced bars defining a plurality of open flow channels between the bars.

3. The basket system of claim 1 wherein the array of parallel structural members comprises a plurality of corrugations in a solid sheet of material, the corrugations defining a plurality of open flow channels between the corrugations.

4. The basket system of claim 1 wherein the basket container further comprises permeable side walls.

5. The basket system of claim 1 further comprising a cover plate sized to serve as a lid for the basket container, wherein the cover plate serves to limit movement of the plurality of thermally conductive plates and multiple frozen objects within the basket container during use.

6. The basket system of claim 5 wherein the cover plate is perforated to allow a flow of liquids therethrough.

7. The basket system of claim 5 wherein the permeable cover plate comprises one or more perimeter tabs and at least one wall of the basket container defines an array of apertures into which the one or more perimeter tabs of the permeable cover plate may engage so as to fix the cover plate at a variable height within the basket container.

8. The basket system of claim 5 wherein the cover plate further comprises at least one handle to facilitate the placement of the cover plate onto or into the basket container.

9. The basket system of claim 2 wherein the plurality of spaced bars is fixed in spaced arrangement by at least one cross-member integral with or attached to each of the spaced bars.

10. The basket system of claim 9 wherein the at least one cross-member is positioned offset from a plane within which the plurality of spaced bars are positioned, whereby the channels defined by the spaced bars are open ended.

11. The basket system of claim 2 wherein the plurality of spaced bars comprises bars having a rectangular cross-section.

12. The basket system of claim 3 wherein the plurality of corrugations comprises corrugations that are sinusoidal in cross-section.

13. The basket system of claim 3 wherein the solid sheet of material is perforated with at least one aperture sized to serve as a finger-hold to facilitate the placement and removal of the plurality of thermally conductive plates into and out from the basket container.

14. The basket system of claim 1 further comprising a perimeter collar fixed on a perimeter edge of the open top of the basket container, the perimeter collar structured to engage a means for holding the basket system while it is immersed into, moved within, and removed from the volume of defrosting fluid.

15. A basket system for facilitating the defrosting of multiple frozen objects being immersed into, moved within, and removed from a volume of defrosting fluid, the basket system comprising;
a basket container having an open top, side walls, and a permeable floor; and
a plurality of plates sized and shaped to be positioned in layers within the basket container, each of the plates comprising a plurality of spaced bars defining a plurality of open flow channels between the bars, each of the plates further comprising at least one cross-member integral with or attached to each of the spaced bars so as to fix the spaced bars in their parallel spaced arrangement;
wherein multiple frozen objects to be defrosted are layered between the plurality of plates, which together are layered within the basket container, thereby providing channels that permit the free flow of defrosting fluid between the layered plates and objects to be defrosted.

16. The basket system of claim 15 wherein the plurality of plates comprise thermally conductive material.

17. The basket system of claim 15 wherein the side walls of the basket container are permeable.

18. The basket system of claim 15 further comprising a permeable cover plate sized to serve as a lid for the basket container.

19. The basket system of claim 18 wherein the permeable cover plate comprises one or more perimeter tabs and at least one side wall of the basket container defines an array of apertures into which the one or more perimeter tabs of the permeable cover plate may engage so as to fix the cover plate at a variable height within the basket container.

20. The basket system of claim 15 wherein the at least one cross-member is positioned offset from a plane within which the plurality of spaced bars are positioned, whereby the channels defined by the spaced bars are open ended.
